(19) United States
(12) Patent Application Publication
(10) Pub. No.: US 2014/0258840 A1
(43) Pub. Date: Sep. 11, 2014

(54) XML BASED CUSTOM CODE GENERATING METHOD AND GENERATOR, COMPUTER PROGRAM PRODUCT AND COMPUTER READABLE MEDIUM

(71) Applicants: Beijing Founder Electronics Co., Ltd., Beijing (CN); Peking University Founder Group Co., Ltd., Beijing (CN)

(72) Inventor: Ji'an BI, Beijing (CN)

(73) Assignees: Beijing Founder Electronics Co., Ltd., Beijing (CN); Peking University Founder Group Co., Ltd., Beijing (CN)

(21) Appl. No.: 14/098,421

(22) Filed: Dec. 5, 2013

(30) Foreign Application Priority Data
Mar. 5, 2013 (CN) 201310068568.2

(51) Int. Cl. G06F 17/22

(52) U.S. Cl. CPC G06F 17/2247
USPC 715/234

(57) ABSTRACT

Embodiments of the present application provide an XML based custom code generating method and an XML based custom code generator, a computer program product and a computer readable medium. The method comprises: obtaining code source information, user custom template file information and a prestored code output format rule; preprocessing the code source information, classifying the code source information and storing the same into a code source container; dynamically replacing a corresponding description part in the user custom template file with the corresponding classified code source information stored in the code source container; and outputting codes in the replaced user defined template file according to the prestored code output format rule. With the method and generator, repeated code can be automatically implemented during the development process, custom extension can be flexibly implemented, the workload of engineers can be reduced and the stability of the system is improved.

### CROSS-REFERENCE TO RELATED APPLICATIONS

The present application claims priority to Chinese Patent Application No. 201310068568.2 filed before the Chinese Patent Office on Mar. 5, 2013 and entitled “XML BASED CUSTOM CODE GENERATING METHOD AND GENERATOR”, which is incorporated herein by reference in its entirety.

### TECHNICAL FIELD

The present invention relates to the field of code generation technology, in particular to an XML based custom code generating method and generator, a computer program product and a computer readable medium.

### BACKGROUND

Along with the development of network technologies, more and more enterprises need to build up their own network platforms. Therefore, a network build up person who builds up an enterprise network platform performs model development for different projects, and produces different products respectively. However, the network platforms of most enterprises have a high similarity, the network build up person needs to program codes to each project and build up network platforms based on different scenes.

When generating codes to build up a network platform, the inventor found that the conventional methods have the issues as follows.

The conventional code generating methods are only to generate codes with a specified format and do not have a good flexibility. A custom code template is hardly to be added and extended to generate custom codes. For project generation methods having a high similarity, codes need to be repeatedly programmed. Therefore, manpower resources are waste and the stability of a system degrades.

### SUMMARY

In order to solve the problems in prior art, the present invention aims to provide an XML based custom code generating method and generator, a computer program product and a computer readable medium.

One aspect of the present invention provides an XML based custom code generating method, comprising:

obtaining code source information, user custom template file information and a prestored code output format rule;

preprocessing the code source information, classifying the code source information and storing the same into a code source container;

dynamically replacing a corresponding description part in the user custom template file with the corresponding classified code source information stored in the code source container; and

outputting codes in the replaced user defined template file according to the prestored code output format rule.

Another aspect of the present invention provides an XML based custom code generator, comprising:

an information obtaining unit, configured to obtain code source information, user custom template file information and a prestored code output format rule;

a preprocessing unit, configured to preprocess the code source information, classify the code source information and store the same to a code source container;

a template parsing unit, configured to dynamically replace a corresponding description in the user custom template file with the corresponding classified code source information stored in the code container; and

a code output unit, configured to output codes in the replaced user custom template file according to the prestored code output format rule.

A yet another aspect of the present invention provides a computer program product embodied on a non-transitory computer readable medium, comprising computer code for implementing the XML based custom code generating method.

A yet another aspect of the present invention provides a non-transitory computer readable medium configured to store the above computer program product.

With the XML based custom code generating method and generator, a computer program product and a non-transitory computer readable medium according to the embodiments of the present invention, repeated code can be automatically implemented during the development process, custom extension can be flexibly implemented, the workload of engineers can be reduced and the stability of the system is improved.

### BRIEF DESCRIPTION OF THE DRAWINGS

FIG. 1 is a flow chart of an XML based custom code generating method according to an embodiment of the present invention;

FIG. 2 is a schematics structure diagram showing an XML based custom code generator according to an embodiment of the present invention;

FIG. 3 is a flow chart of a specific implementing example of an XML based custom code generator according to the embodiment of the present invention;

FIG. 4 is a schematics structure diagram showing a database resource object table in the XML based custom code generator according to an embodiment of the present invention;

FIG. 5 is a schematic structure diagram of fields in the database resource object table in the XML based custom code generator according to an embodiment of the present invention;

FIG. 6 is a schematic structure diagram of xml resource objects in the XML based custom code generator according to an embodiment of the present invention; and

FIG. 7 is a schematics structure diagram of an object interface to extend input resource in the XML based custom code generator according to an embodiment of the present invention.

### DETAILED DESCRIPTION

An XML based custom code generating method and an XML based custom code generator according to embodiments of the present invention are described hereinafter in conjunction with the drawings as well as embodiments.

As shown in FIG. 1, an embodiment of the present invention provides an XML based custom generating method, the method comprises the following steps.

Step 101: obtaining code source information, user custom template file information and a prestored code output format rule.

Step 102: preprocessing the code source information, classifying the code source information and store the same into a code source container; this step comprising:

parsing the code source information;

if the code source information is database information, obtaining an Er model set and storing the Er model set into a corresponding position of the code source container;

if the code source information is XML resource file information, obtaining an XML resource reference set and storing the XML resource reference set into a corresponding position of the code source container; and

if the code source information is extended code source information, obtaining an extended code source object set, and storing the extended code source object set into a corresponding position of the code source container.

Step 103: dynamically replacing the corresponding description part in the user custom template file with the corresponding classified code source information stored in the code container, this step comprising:

obtaining the parsed code source information and the user custom template file; and

dynamically replacing the corresponding description in the user custom template file with the parsed code source information by a template language parsing engine.

Step 104: outputting codes in the replaced user custom template file according to the prestored code output format rule, this step comprising:

obtaining the code output format rule by an XML template control file; and

implementing format processing to the codes in the replaced user custom template file based on the code output format rule and outputting the processed code to a designated position.

It is noted that the method further comprises:

storing a storage position of the code source information, a storage position of the user custom template file information and the code output format rule into an XML template control file;

obtaining the code source information, the user custom template file information and the code output format rule based on information stored in the XML template control file.

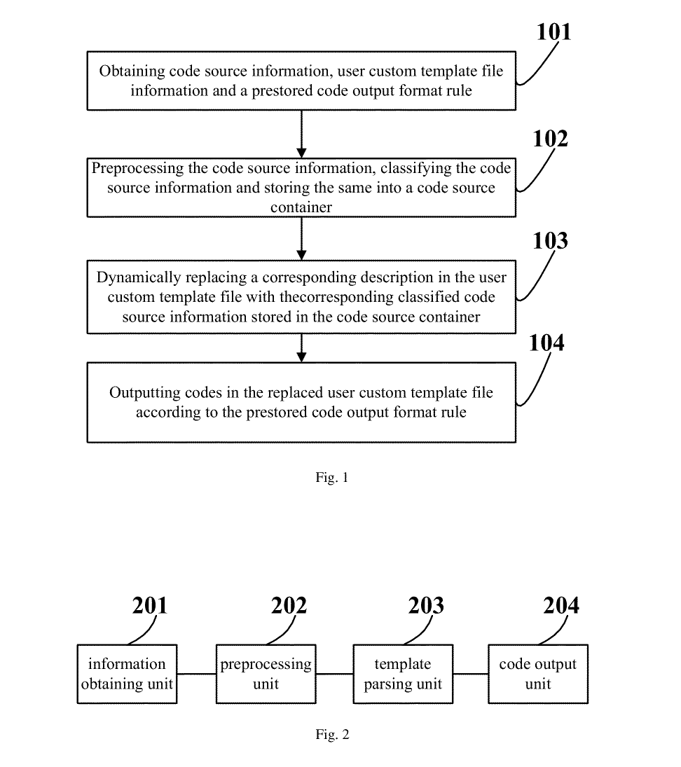

As shown in FIG. 2, an embodiment of the present invention provides an XML based custom code generator, the generator comprises:

an information obtaining unit 201, configured to obtain code source information, user custom template file information and a prestored code output format rule;

a preprocessing unit 202, configured to preprocess the code source information, classify the code source information and store the same to a code source container; the preprocessing unit comprising:
a parsing subunit, configured to parse the code source information;
a code source container, configured to obtain an Er model set and store the Er model set into a corresponding position of the code source container if the code source information is database information, to obtain an XML resource reference set and store the XML resource reference set into a corresponding position of the code source container if the code source information is XML resource file information, and to obtain an extended code source object set and store the extended code source object set into a corresponding position of the code source container if the code source information is extended code source information;

a template parsing unit 203, configured to dynamically replace a corresponding description in the user custom template file with the corresponding classified code source information stored in the code container, the template parsing unit comprising:
an information obtaining subunit, configured to obtain the parsed code source information and the user custom template file; and
a parsing engine subunit, configured to dynamically replace the corresponding description in the user custom template file with the parsed code source information by a temple language parsing engine; and

a code output unit 204, configured to output codes in the replaced user custom template file according to the prestored code output format rule.

Specifically, the code output unit is configured to obtain the code output format rule by an XML template control file, implement format processing to the codes in the replaced user custom template file according to the code output format rule, and output the processed codes to a designated position.

It is noted that the generator further comprises an XML template control file storing unit that is configured to store a storage position of the code source information, a storage position of the user custom template file information and the code output format rule into an XML template control file.

The information obtaining unit obtains the code source information, the user custom template file information and the code output format rule based on the information stored in the XML template control file.

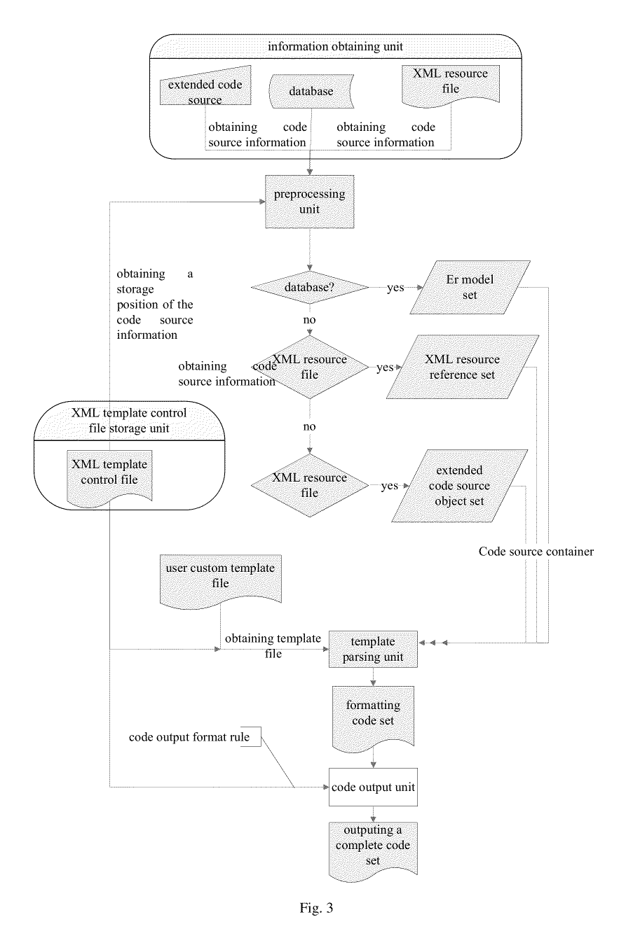

Based on the above description, each part of the XML based custom code generator is described in conjunction with the embodiments of the present invention. FIG. 3 shows the parts of the XML based custom code generator.

I. XML Template Control File Storing Unit

The XML template control file stored in the XML template control file storing unit is the core of the design of the generator. The main functionalities of the XML template control file are to describe the storing position of the code source information used for the preprocessing unit, describe the storing position of the user defined template file used for the template parsing unit, and describe the code output format rule used for the code output unit.

The xsd specification of the XML template control file is as follows.

```
<?xml version=“1.0” encoding=“UTF-8”?>
<xs:schema xmlns=“http://www.kylinhunter.com/2012/
codehelper_config”
xmlns:xs=“http://www.w3.org/2001/XMLSchema”
targetNamespace=“http://www.kylinhunter.com/2012/codehelper_config”
elementFormDefault=“qualified” attributeFormDefault=“unqualified”>
  <xs:simpleType name=“stringtype”>
    <xs:restriction base=“xs:string”/>
  </xs:simpleType>
  <xs:simpleType name=“inttype”>
    <xs:restriction base=“xs:positiveInteger”/>
  </xs:simpleType>
  <xs:simpleType name=“dectype”>
    <xs:restriction base=“xs:decimal”/>
  </xs:simpleType>
  <xs:complexType name=“xmlRresourcetype”>
    <xs:sequence>
      <xs:element name=“id” type=“stringtype”/>
      <xs:element name=“path” type=“stringtype”/>
    </xs:sequence>
  </xs:complexType>
  <xs:complexType name=“dbRresourcetype”>
    <xs:sequence>
      <xs:element name=“id” type=“stringtype”/>
      <xs:element name=“driverClass” type=“stringtype”/>
      <xs:element name=“url” type=“stringtype”/>
      <xs:element name=“username” type=“stringtype”/>
      <xs:element name=“password” type=“stringtype”/>
    </xs:sequence>
  </xs:complexType>
  <xs:complexType name=“templatetype”>
    <xs:sequence>
      <xs:element name=“id” type=“stringtype”/>
      <xs:element name=“path” type=“stringtype”/>
    </xs:sequence>
  </xs:complexType>
  <xs:complexType name=“copydirtype”>
    <xs:sequence>
      <xs:element name=“resource” type=“stringtype”/>
      <xs:element name=“from” type=“stringtype”/>
      <xs:element name=“to” type=“stringtype”/>
    </xs:sequence>
  </xs:complexType>
  <xs:complexType name=“copytype”>
    <xs:sequence>
      <xs:element name=“resource” type=“stringtype”/>
      <xs:element name=“from” type=“stringtype”/>
      <xs:element name=“to” type=“stringtype”/>
    </xs:sequence>
  </xs:complexType>
  <xs:complexType name=“copytemplatetype”>
    <xs:sequence>
      <xs:element name=“templateid” type=“stringtype”/>
      <xs:element name=“to” type=“stringtype”/>
    </xs:sequence>
  </xs:complexType>
  <xs:complexType name=“outputtype”>
    <xs:sequence>
      <xs:element name=“basedir” type=“stringtype”
maxOccurs=“unbounded”/>
      <xs:element name=“copydir” type=“copydirtype”
maxOccurs=“unbounded”/>
      <xs:element name=“copy” type=“copytype” maxOccurs=
      “unbounded”/>
      <xs:element name=“copytemplate” type=“copytemplatetype”
maxOccurs=“unbounded”/>
    </xs:sequence>
  </xs:complexType>
  <xs:complexType name=“codehelperconfigtype”>
    <xs:sequence>
      <xs:element name=“xmlRresource” type=“xmlRresourcetype”
minOccurs=“0” maxOccurs=“unbounded”/>
      <xs:element name=“dbRresource” type=“dbRresourcetype”
minOccurs=“0” maxOccurs=“unbounded”/>
      <xs:element name=“template” type=“templatetype”
maxOccurs=“unbounded”/>
      <xs:element name=“output” type=“outputtype”
maxOccurs=“unbounded”/>
    </xs:sequence>
  </xs:complexType>
  <xs:element name=“codehelperconfig” type=“codehelperconfigtype”/>
</xs:schema>
  An instance of the basic code of the XML template control file is as
  follows.
<?xml version=“1.0” encoding=“UTF-8”?>
<codehelperconfig xmlns=“http://www.kylinhunter.com/2012/
codehelper_config”
xmlns:xsi=“http://www.w3.org/2001/XMLSchema-instance”
xsi:schemaLocation=“http://www.kylinhunter.com/2012/
codehelper_config codehelper_config.xsd”>
  <xmlRresource>
    <id>1</id>
    <!--declare a xml resource file resource1.xml-->
    <path>d:\resource\resource1.xml</path>
  </xmlRresource>
  <dbRresource>
    <!--declare a data code source-->
    <id>1</id>
    <driverClass>oracle.jdbc.OracleDriver</driverClass>
    <url>jdbc:oracle:thin:@172.16.95.35:1521:newsedit</url>
    <username>newsedit</username>
    <password>newsedit</password>
  </dbRresource>
  <template>
    <id>1</id>
    <!--declare a xml custom template file template1.tplt-->
    <path>d:\resource\template1.tplt</path>
  </template>
  <template>
    <id>2</id>
    <path>d:\resource\template2.tplt</path>
    <!--declare a xml custom template file template2.tplt-->
  </template>
  <output>
    <basedir>d:\dest\</basedir>
    <copydir>
      <!--the folder to be copied origins from a xml resource file with id
of 1-->
      <resource>1</resource>
      <!--the folder to be copied is the resource with id
of 2-->
      <from>resource$2</from>
      <!--copy the folder to a web-info folder-->
      <to>/web-info/</to>
    </copydir>
    <copy>
      <!--the file to be copied origins from an xml resource file with id
      of 1-->
      <resource>1</resource>
      <!--the file to be copied is the resource with id of 4-->
      <from>resource$4</from>
      <!--copy files to the web-info/classess folder-->
      <to>/web-info/classess/</to>
    </copy>
    <copytemplate>
      <!--copy the generation result of the template with id of 2 to the
directory /web-info/classess/com/khp/-->
      <templateid>2</templateid>
      <to>/web-info/classess/com/khp/</to>
    </copytemplate>
  </output>
</codehelperconfig>
```

II. Information Obtaining Unit

The code source information obtained by the information obtaining unit may be classified into three kinds: database information, XML resource file information and extended code source information. The three kinds of code source information are described as follows.

The database information is some codes which are dynamically built up by the code generator according to one or some specific database connection. Reference is made to the declaration part dbRresourcetype in the above mentioned XML object control file.

The XML resource file information is a position where another main dynamic data is generated except for the database information. The XML resource file information stores some user custom resource types which can also be used to dynamically build up codes. Reference is made to the declaration part dbRresourcetype in the above mentioned XML object control file.

The extended code source information is mainly used for extension and aims to use some other resources (for example, excel files) to build up code source of dynamic codes. In order to use the extended code source information, the above mentioned xsd is firstly extended. The xsd is friendly supporting extension. Certainly, the corresponding preprocessing unit and the template parsing unit need to be extended so as to recognize the information input, which will be described later.

III. Preprocessing Unit

The preprocessing unit is mainly used to recognize various types of code source information and reasonably package them so as to be easily used for the template parsing unit. The main principle is to parse each piece of code source information, and divide the parsed code source into a group of resource objects. The group of resource objects is put into a corresponding code source container. Specifically, a harsh table may be selected and used for the template parsing unit.

The specific resource objects of various code sources are described as follows.

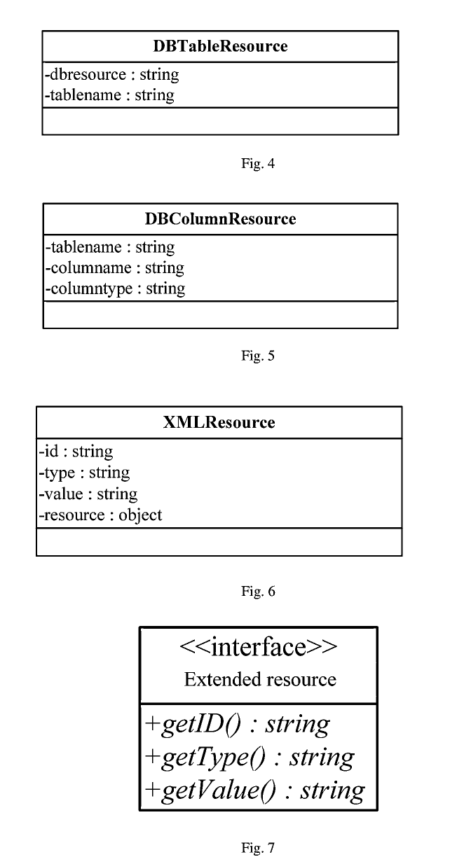

The database resource object consists of several tables as defined in FIG. 4. The main attributes thereof are dbresource (database connection identification) and columnname (field name).

Each table consists of several fields as defined in FIG. 5. The main attributes thereof are tablename (table name), columnname (field name) and columntype (field type).

In summary, resource objects generated by a database connection have several DBTableResource instances, each DBTableResource instance relates to several DBColumnResource instances.

The XML resouece file information may comply with the xsd specification as follows.

```
<?xml version=“1.0” encoding=“UTF-8”?>
<xs:schema xmlns=“http://www.kylinhunter.com/2012/
codehelper_xml_resource”
xmlns:xs=“http://www.w3.org/2001/XMLSchema”
targetNamespace=“http://www.kylinhunter.com/2012/
codehelper_xml_resource”
elementFormDefault=“qualified” attributeFormDefault=“unqualified”>
  <xs:simpleType name=“stringtype”>
    <xs:restriction base=“xs:string”/>
  </xs:simpleType>
  <xs:simpleType name=“inttype”>
    <xs:restriction base=“xs:positiveInteger”/>
  </xs:simpleType>
  <xs:simpleType name=“dectype”>
    <xs:restriction base=“xs:decimal”/>
  </xs:simpleType>
  <xs:complexType name=“itemtype”>
    <xs:sequence>
      <xs:element name=“id” type=“stringtype”/>
      <xs:element name=“type” type=“stringtype”/>
      <xs:element name=“value” type=“stringtype”/>
      <xs:element name=“item” type=“itemtype” minOccurs=“0”/>
    </xs:sequence>
  </xs:complexType>
  <xs:complexType name=“resourcestype”>
    <xs:sequence>
      <xs:element name=“resourcesCode” type=“stringtype”/>
      <xs:element name=“item” type=“itemtype” maxOccurs=
      “unbounded”/>
    </xs:sequence>
  </xs:complexType>
  <xs:element name=“resources” type=“resourcestype”/>
</xs:schema>
```

According to the above specification, the XML resource file is shown as follows.

```
<?xml version=“1.0” encoding=“UTF-8”?>
<resources xmlns=“http://www.kylinhunter.com/2012/
codehelper_xml_resource”
xmlns:xsi=“http://www.w3.org/2001/XMLSchema-instance”
xsi:schemaLocation=“http://www.kylinhunter.com/2012/
codehelper_xml_resource
codehelper_xml_resource.xsd”>
  <resourcesCode>George Bush</resourcesCode>
  <resource><!--declare a resource-->
    <id>1</id>
    <type>1</type><!-- declare a digital resouce-->
    <value>1111</value>
    <resource><!-- declare a embedded resouce-->
      <id>4</id>
      <type>3</type><!--declare a folder resource-->
      <value>d:\\resource\\lib</value>
    </resource>
  </resource>
  <resource><!--declare a resource-->
    <id>3</id>
    <type>2</type><!--declare a character string resource-->
    <value>hello</value>
    <resource><!--declare an embedded resource-->
      <id>4</id>
      <type>3</type><!--declare a file resource-->
      <value>d:\\resource\\base.jar</value>
    </resource>
  </resource>
</resources>
```

By observing the xsd specification and an example xml, the xml resource objects may be defined as in FIG. 6. The main attributes are id (resource id), type (resource type, for example, resource being designated as a number, a character string or as file (a folder) and so on), value (resource value), and resource (other resource objects), which has a recursive nested relationship, that is, other resources are in a resource.

It should be noted that in the xml resource objects, the support to the files (the folders) is very important, because some files (folders) that are stable and do not need to be revised are commonly used as the output results of the code generator. These files are mainly some stable third party library files, some library files developed in the system and any file that does not need to be revised.

The preprocessing unit and the template paring unit which support extended code sources are required for the extended code source to extend the code source information. Therefore, the following requirements must to be met.

Firstly, in the practical implementation, the preprocessing unit must reserve an extension interface, the interface is dedicated to dynamically parse the extended code source declared in the xml template control file to generate a dynamically extended input resource object, and put the dynamically extended input resource object into an extended resource container to be used for the template parsing unit.

Secondly, the object of the extended input resource needs to implement a specific interface used for the extended template parsing unit. The interface is shown in FIG. 7. The main interface includes getID (obtaining resource identification), getType (obtaining resource type which can be defined by the user) and getvalue (obtaining resource value).

The interface facilitates the extended template parsing unit to recognize id, type and value of the extended resource from the extended code source.

IV. User Custom Template File

The specific codes generated by the user origins from the custom template. The template may use many template languages, Take Java as an example, the template language may include Freemaker and jsp. The template languages may obtain various dynamic resources from the resource container or the extended resource container, for example, the dynamic resources may be all fields in a table, a picture provided by an xml resource file, and so on.

The user custom template will be declared in <template> part of the XML template control file.

V. Template Parsing Unit

The main functionalities of the template parsing unit are to obtain resource from a code source container, and deliver the resource to a template language parsing engine, the template language parsing unit dynamically replaces the description part of the template language in the user custom template. Taking Java as an example, if freemaker is selected, the template parsing unit changes the resource object in the resource container or the extended resource container into resource which can be indentified by the freemaker language parsing engine, then the resource is processed by a freemaker language parser. Certainly, the procedure for freemaker is also available for other template language. Finally, although existing template languages are well developed, a capable developer still can selectively develop a template language, including a language parsing engine.

If an extended code source is used, the template parsing unit should be extended in order that the template parsing unit supports the extended code source. Therefore, an extension interface should be reserved in the template parsing unit, and the default template parsing unit can be enhanced by the interface, so as to obtain resource from the extended resource container and deliver the resource to the template language parsing engine.

VI. Code Output Unit

The code output unit output the above generated result code and the file (folder) resource designated in the XML resource file to an appointed position according to the combination output specification defined in the XML template control file.

For example, the XML template control file has the configuration segments as follows.

```
  <output>
    <basedir>d:\dest\</basedir>
    <copydir>
    <!--the folder to be copied origins from the xml resource file with the
id of 1-->
      <resource>1</resource>
      <!--the folder to be copied is the resource with id of 2-->
      <from>resource$2</from>
      <!-- copy the folder to the folder web-info-->
      <to>/web-info/</to>
    </copydir>
    <copy>
    <!--a file to be copied origins from the xml resource file with id of
    1-->
      <resource>1</resource>
      <!--the file to be copied is the resource with id of 4-->
      <from>resource$4</from>
      <!-- copy the file to the folder web-info/classess-->
      <to>/web-info/classess/</to>
    </copy>
    <copytemplate>
    <!--copy the result generated by the template with id of 2 to the
directory/web-info/classess/com/khp/-->
      <templateid>2</templateid>
      <to>/web-info/classess/com/khp/</to>
    </copytemplate>
  </output>
```

The configuration segments means:

copying the folder with id of 2 from the xml resource file with id of 1 to d:\dest\web-info;

copying the file with id of 4 from the xml resource file with id of 1 to d:\dest\web-info\classess; and

copying the result generated by the template with id of 2 to d:\dest\web-info\classess\com\khp

One embodiment of the present invention provides an XML based custom code generating method, comprising: obtaining code source information, user custom template file information and a prestored code output format rule; preprocessing the code source information, classifying the code source information and storing the same into a code source container; dynamically replacing a corresponding description in the user custom template file with the corresponding classified code source information stored in the code container; outputting codes in the replaced user custom template file according to the prestored code output format rule. One embodiment of the present invention also provided an XML based custom code generator to execute the method. With the XML based custom code generating method and the XML based custom code generator according to the embodiments of the present invention, repeated code can be automatically implemented during the development process, custom extension can be flexibly implemented, the workload of the engineers can be reduced and the stability of the system is improved.

It is appreciated that all or part steps in the above example method may be implemented by a corresponding hardware instructed by a computer program. The computer program may be stored in a computer readable storage medium. When executed, the computer program implements the steps of the above method. The storage medium is ROM/RAM, a disk or an optical disk.

The above are merely the preferred embodiments of the present invention. It should be noted that, a person skilled in the art may make improvements and modifications without departing from the principle of the present invention, and these improvements and modifications shall also fall into the scope of the present invention.

1. An XML based custom code generating method, comprising:
obtaining code source information, user custom template file information and a prestored code output format rule;
preprocessing the code source information, classifying the code source information and storing the same into a code source container;
dynamically replacing a corresponding description part in the user custom template file with the corresponding classified code source information stored in the code source container; and
outputting codes in the replaced user defined template file according to the prestored code output format rule.

2. The method according to claim 1, further comprising:
storing a storage position of the code source information, a storage position of the user custom template file information and the code output format rule into an XML template control file;
obtaining the code source information, the user custom template file information and the code output format rule based on information stored in the XML template control file.

3. The method according to claim 2, wherein the step of preprocessing the code source information, classifying the code source information and storing the same into a code source container further comprising:
parsing the code source information;
if the code source information is database information, obtaining an Er model set and storing the Er model set into a corresponding position of the code source container;
If the code source information is XML resource file information, obtaining an XML resource reference set and storing the XML resource reference set into a corresponding position of the code source container; and
If the code source information is extended code source information, obtaining an extended code source object set and storing the extended code source object set into a corresponding position of the code source container.

4. The method according to claim 3, wherein the step of dynamically replacing a corresponding description part in a user custom template file with the corresponding classified code source information stored in the code source container further comprising:
obtaining the parsed code source information and the user custom template file;
dynamically replacing the corresponding description in the user custom template file with the parsed code source information by a template language parsing engine.

5. The method according to claim 4, wherein the step of outputting the codes in the replaced user custom template file according to the prestored code output format rule further comprising:
obtaining the code output format rule by an XML template control file; and
implementing format processing to the codes in the replaced user custom template file based on the code output format rule and outputting the processed codes to a designated position.

6. An XML based custom code generator, comprising:
an information obtaining unit, configured to obtain code source information, user custom template file information and a prestored code output format rule;
a preprocessing unit, configured to preprocess the code source information, classify the code source information and store the same to a code source container;
a template parsing unit, configured to dynamically replace a corresponding description in the user custom template file with the corresponding classified code source information stored in the code container; and
a code output unit, configured to output codes in the replaced user custom template file according to the prestored code output format rule.

7. The generator according to claim 6, further comprising:
an XML template control file storing unit, configured to store a storage position of the code source information, a storage position of the user custom template file information storage position and the code output format rule into an XML template control file,
wherein the information obtaining unit obtains the code source information, the user custom template file information and the code output format rule based on information stored in the XML template control file.

8. The generator according to claim 7, wherein the preprocessing unit further comprises:
a parsing subunit, configured to parse the code source information;
a code source container, configured to obtain an Er model set and store the Er model set into a corresponding position of the code source container if the code source information is database information, to obtain an XML resource reference set and store the XML resource reference set into a corresponding position of the code source container if the code source information is XML resource file information, and to obtain an extended code source object set and store the extended code source object set into a corresponding position of the code source container if the code source information is extended code source information.

9. The generator according to claim 8, wherein the template parsing unit further comprises:
an information obtaining subunit, configured to obtain the parsed code source information and the user custom template file; and
a parsing engine subunit, configured to dynamically replace the corresponding description in the user custom template file with the parsed code source information by a template language parsing engine.

10. The generator according to claim 9, wherein the code output unit is configured to obtain the code output format rule by an XML template control file, implement format processing to the codes in the replaced user custom template file according to the code output format rule, and output the processed codes to a designated position.

11. A computer program product embodied on a non-transitory computer readable medium, comprising computer code for implementing the method according to claim 1.

12. A non-transitory computer readable medium configured to store the computer program product according to claim 11.
